(19) United States
(12) Patent Application Publication
(10) Pub. No.: US 2020/0076809 A1
(43) Pub. Date: Mar. 5, 2020

(54) DISPLAY APPARATUS, DISPLAY SYSTEM, CONTROL METHOD OF DISPLAY APPARATUS, AND CONTROL METHOD OF DISPLAY SYSTEM

(71) Applicant: SEIKO EPSON CORPORATION, Tokyo (JP)

(72) Inventor: Takashi NATORI, Suwa-shi (JP)

(73) Assignee: SEIKO EPSON CORPORATION, Tokyo (JP)

(21) Appl. No.: 16/557,589

(22) Filed: Aug. 30, 2019

(30) Foreign Application Priority Data
Sep. 3, 2018 (JP) 2018-164240

(51) Int. Cl. H04L 29/06; G06F 3/14; H04W 12/08

(52) U.S. Cl. CPC H04L 63/10; H04N 9/3197; H04W 12/08; G06F 3/14

(57) ABSTRACT

A display apparatus includes: a first connection unit that establishes a communication connection with a first electronic apparatus when receiving valid authentication information from the first electronic apparatus; an inquiry unit that executes an inquiry for a communication connection with a second electronic apparatus to the first electronic apparatus when receiving a request related to communication from the second electronic apparatus in a state in which the communication connection with the first electronic apparatus is established; and a second connection unit that establishes the communication connection with the second electronic apparatus when a response to the inquiry indicates permission for the communication connection with the second electronic apparatus.

The present application is based on, and claims priority from JP Application Serial Number 2018-164240, filed Sep. 3, 2018, the disclosure of which is hereby incorporated by reference herein in its entirety

### BACKGROUND

### 1. Technical Field

The present disclosure relates to a display apparatus, a display system, a control method of the display apparatus, and a control method of the display system.

### 2. Related Art

JP-A-2011-118243 discloses a technology of authenticating an electronic apparatus which requests a connection to a display apparatus such as a projector or the like by using authentication information such as a password or the like. In this technology, the electronic apparatus transmits authentication information according to an input of the authentication information from a user to the display apparatus. When the display apparatus successfully authenticates the electronic apparatus by using the authentication information, the display apparatus establishes a communication connection between the display apparatus and the electronic apparatus.

In JP-A-2011-118243, when a plurality of electronic apparatuses are connected to the display apparatus, it is necessary to always input authentication information for each of the electronic apparatuses and it takes time and effort to input the authentication information.

### SUMMARY

A display apparatus according to an aspect of the present disclosure includes: a first connection unit that establishes a communication connection with a first electronic apparatus when receiving valid authentication information from the first electronic apparatus; an inquiry unit that executes an inquiry for a communication connection with a second electronic apparatus to the first electronic apparatus when receiving a request related to communication from the second electronic apparatus in a state in which the communication connection with the first electronic apparatus is established; and a second connection unit that establishes the communication connection with the second electronic apparatus when a response to the inquiry indicates permission for the communication connection with the second electronic apparatus.

A display apparatus according to another aspect of the present disclosure includes: a first connection unit that establishes a communication connection with a first electronic apparatus when receiving valid authentication information from the first electronic apparatus; and a third connection unit that establishes a communication connection with a second electronic apparatus when receiving a request related to communication from the second electronic apparatus in a first state in which the communication connection with the first electronic apparatus is established and when the second electronic apparatus is indicated in permission apparatus information indicating an electronic apparatus for which a communication connection with the display apparatus is permitted in the first state.

A display system according to still another aspect of the present disclosure includes: a display apparatus; a first electronic apparatus; and a second electronic apparatus, in which the first electronic apparatus transmits valid authentication information and transmits a response to an inquiry for a communication connection with the second electronic apparatus, the second electronic apparatus transmits a request related to communication, and the display apparatus includes a first connection unit that establishes a communication connection with the first electronic apparatus when receiving the valid authentication information from the first electronic apparatus, an inquiry unit that executes the inquiry to the first electronic apparatus when receiving a request related to the communication from the second electronic apparatus in a state in which the communication connection with the first electronic apparatus is established, and a second connection unit that establishes the communication connection with the second electronic apparatus when a response to the inquiry indicates permission for the communication connection with the second electronic apparatus.

A control method according to still another aspect of the present disclosure is a control method of a display apparatus, the method including: establishing a communication connection with a first electronic apparatus when receiving valid authentication information from the first electronic apparatus; executing an inquiry for a communication connection with a second electronic apparatus to the first electronic apparatus when receiving a request related to communication from the second electronic apparatus in a state in which the communication connection with the first electronic apparatus is established; and establishing the communication connection with the second electronic apparatus when a response to the inquiry indicates permission for the communication connection with the second electronic apparatus.

A control method according to still another aspect of the present disclosure is a control method of a display system including a display apparatus, a first electronic apparatus, and a second electronic apparatus, the method including: transmitting valid authentication information by the first electronic apparatus; establishing a communication connection with the first electronic apparatus by the display apparatus when receiving the valid authentication information from the first electronic apparatus; transmitting a request related to communication by the second electronic apparatus; executing an inquiry for a communication connection with the second electronic apparatus to the first electronic apparatus by the display apparatus when receiving a request related to communication from the second electronic apparatus in a state in which the communication connection with the first electronic apparatus is established; transmitting a response to the inquiry by the first electronic apparatus; and establishing the communication connection with the second electronic apparatus by the display apparatus when a response to the inquiry indicates permission for the communication connection with the second electronic apparatus.

### BRIEF DESCRIPTION OF THE DRAWINGS

FIG. 1 is a diagram illustrating an example of a display system.

FIG. 2 is a diagram illustrating an example of a projector.

FIG. 3 is a diagram illustrating an example of a first electronic apparatus.

FIG. 4 is a sequence diagram for explaining an example of an operation of the display system.

FIG. 5 is a diagram illustrating an example of an inquiry image.

FIG. 6 is a sequence diagram for explaining an example of another operation of the display system.

FIG. 7 is a flowchart for explaining an example of an operation of the projector.

FIG. 8 is a flowchart for explaining an example of an operation of the first electronic apparatus.

FIG. 9 is a diagram illustrating an example of permission apparatus information.

FIG. 10 is a diagram illustrating an example of a projector according to Modification Example 2.

### DESCRIPTION OF EXEMPLARY EMBODIMENTS

### A: First Embodiment

### A1: Outline of Display System 1

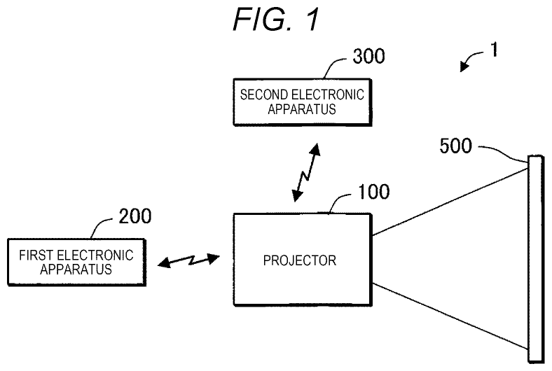

FIG. 1 is a diagram illustrating an example of a display system 1 including a projector 100 according to a first embodiment. The display system 1 includes the projector 100, a first electronic apparatus 200, and a second electronic apparatus 300.

The first electronic apparatus 200 and the second electronic apparatus 300 are, for example, information processing apparatuses such as personal computers (PCs) and the like configured to output image information indicating an image. Each of the first electronic apparatus 200 and the second electronic apparatus 300 is not limited to a PC, and may be, for example, a portable device such as a smartphone. The number of each of the first electronic apparatus 200 and the second electronic apparatus 300 may be one or more.

Each of the first electronic apparatus 200 and the second electronic apparatus 300 communicates with the projector 100 in a wired or wireless manner. For example, each of the first electronic apparatus 200 and the second electronic apparatus 300 communicates with the projector 100 via a wireless local area network (LAN).

Each of the first electronic apparatus 200 and the second electronic apparatus 300 transmits image information to the projector 100. Hereinafter, the image information transmitted by the first electronic apparatus 200 is referred to as “first image information”. The image information transmitted by the second electronic apparatus 300 is referred to as “second image information”.

The projector 100 is an example of a display apparatus. The projector 100 establishes a communication connection with each of the first electronic apparatus 200 and the second electronic apparatus 300. For example, the projector 100 projects and displays an image based on the first image information on a projection surface 500, or projects and displays an image based on the second image information on the projection surface 500.

Hereinafter, an example in which the first electronic apparatus 200 is used by a teacher and the second electronic apparatus 300 is used by a student will be described. It is needless to say that the first electronic apparatus 200 may be used by a person who is not a teacher and the second electronic apparatus 300 may be used by a person who is not a student.

When the first electronic apparatus 200 used by the teacher is authenticated by using a valid password for a communication connection set in the projector 100 and the authentication succeeds, the projector 100 establishes the communication connection with the first electronic apparatus 200. Hereinafter, a valid password for a communication connection is referred to as “a valid password”. The valid password is an example of valid authentication information. The valid authentication information is not limited to the valid password, and may be a valid keyword or can be appropriately changed.

When the second electronic apparatus 300 used by the student satisfies a predetermined condition, the projector 100 establishes a communication connection with the second electronic apparatus 300 without authentication using a valid password.

### A2: Configuration Example of Projector 100

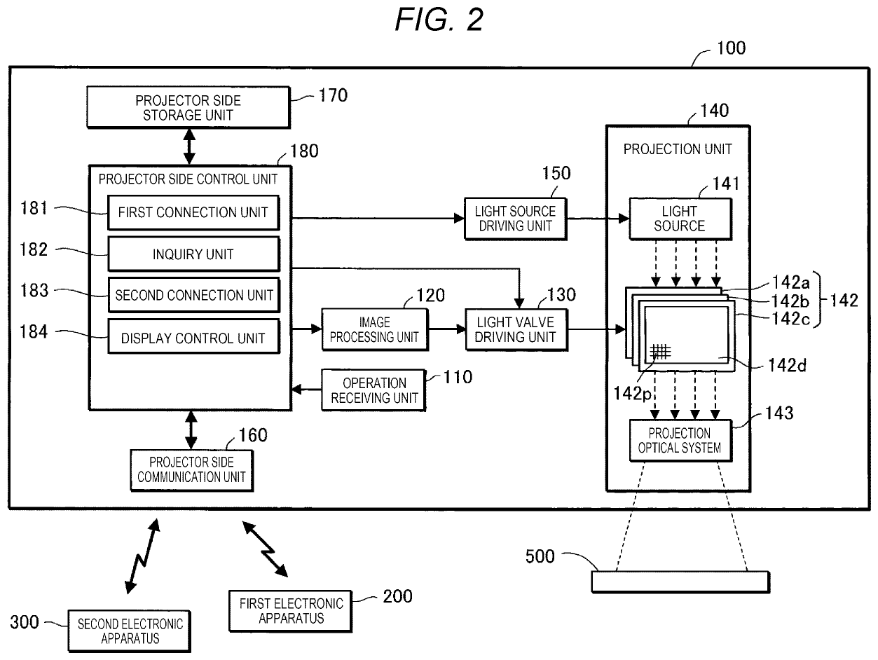

FIG. 2 is a diagram illustrating an example of the projector 100 described above. The projector 100 includes an operation receiving unit 110, an image processing unit 120, a light valve driving unit 130, a projection unit 140, a light source driving unit 150, a projector side communication unit 160, a projector side storage unit 170, and a projector side control unit 180. The projection unit 140 includes a light source 141, an R-type liquid crystal light valve 142a, a G-type liquid crystal light valve 142b, a B-type liquid crystal light valve 142c, and a projection optical system 143.

Here, “R” means red. “G” means green. “B” means blue. When it is not necessary to distinguish the R-type liquid crystal light valve 142a, the G-type liquid crystal light valve 142b, and the B-type liquid crystal light valve 142c from one another, each of the R-type liquid crystal light valve 142a, the G-type liquid crystal light valve 142b, and the B-type liquid crystal light valve 142c is simply referred to as “a liquid crystal light valve 142”. The liquid crystal light valve 142 is configured with a liquid crystal panel. The liquid crystal light valve 142 functions as a light modulation device which modulates light.

The operation receiving unit 110 is, for example, each of various operation buttons, an operation key, or a touch panel. The operation receiving unit 110 receives an input operation of a user. The operation receiving unit 110 may be a remote controller which transmits information based on the input operation in a wired or wireless manner. In this case, the projector 100 includes a receiving unit which receives the information from the remote controller. The remote controller includes various operation buttons, an operation key, or a touch panel which receives an input operation. In addition, the operation receiving unit 110 may be a wireless receiving unit which wirelessly receives an operation input to an application operating on an information terminal device such as a smartphone or the like from the information terminal device.

The image processing unit 120 generates an image signal by performing an image process on the first image information or the second image information. The image processing unit 120 may generate image information indicating a synthesis image in which image represented by the first image information and image represented by the second image information are synthesized, and may generate an image signal by performing an image process on image information indicating the synthesis image. The image process performed by the image processing unit 120 includes, for example, a resolution conversion process or a frame rate conversion process. In the resolution conversion process, the image processing unit 120 converts resolution of image information into resolution designated by the projector side control unit 180, for example, resolution of the liquid crystal light valve 142. In the frame rate conversion process, the image processing unit 120 converts a frame rate of the image information into a frame rate designated by the projector side control unit 180. The image processing unit 120 may perform both of the resolution conversion process and the frame rate conversion process, or may perform another image process, for example, a so-called gamma correction process.

Based on the image signal generated by the image processing unit 120, the light valve driving unit 130 drives the liquid crystal light valve 142, specifically, the R-type liquid crystal light valve 142a, the G-type liquid crystal light valve 142b, and the B-type liquid crystal light valve 142c.

The projection unit 140 projects a projection image based on the image information onto the projection surface 500. The projection unit 140 is an example of a display unit. The projection surface 500 is an example of a display surface. The projection surface 500 is, for example, a screen. The projection surface 500 is not limited to the screen, and can be appropriately changed. For example, the projection surface 500 may be a wall or a whiteboard.

For example, the light source 141 is a light emitting diode (LED). The light source 141 is not limited to the LED, and can be appropriately changed. For example, the light source 141 may be a xenon lamp, an extra-high pressure mercury lamp, or a laser light source.

Variations in luminance distribution of light emitted from the light source 141 are reduced by an integrator optical system (not illustrated). After then, the light emitted from the light source 141 is separated into color light components of R, G, and B which are three primary colors of light by a color separation optical system (not illustrated). The color light component of R is input to the R-type liquid crystal light valve 142a. The color light component of G is input to the G-type liquid crystal light valve 142b. The color light component of B is input to the B-type liquid crystal light valve 142c.

The liquid crystal light valve 142 is configured with, for example, a liquid crystal panel in which a liquid crystal exists between a pair of transparent substrates. The liquid crystal light valve 142 has a rectangular pixel area 142d including a plurality of pixels 142p arranged in a matrix. In the liquid crystal light valve 142, a driving voltage is applied to each of the pixels 142p for the liquid crystal.

When the light valve driving unit 130 applies a driving voltage based on an image signal input from the image processing unit 120 to each of the pixels 142p, a light transmittance of each of the pixels 142p is set to a light transmittance based on the image signal. For this reason, light emitted from the light source 141 is modulated by penetrating the pixel area 142d, and an image based on the image signal is formed for each of color light beams. A color synthesis optical system (not illustrated) generates a color image by synthesizing images generated by the respective liquid crystal light valves 142 for each pixel 142p.

The projection optical system 143 enlarges the color image generated by the color synthesis optical system to generate a projection image, and projects and displays the projection image onto the projection surface 500.

The light source driving unit 150 drives the light source 141. For example, when the operation receiving unit 110 receives an operation input of power-on, the light source driving unit 150 causes the light source 141 to emit light.

The projector side communication unit 160 wirelessly communicates with each of the first electronic apparatus 200 and the second electronic apparatus 300.

The projector side storage unit 170 is a recording medium configured to be read by a computer. The projector side storage unit 170 stores a program which defines an operation of the projector 100 and various information. The projector side storage unit 170 stores a valid password as a part of the various information. The valid password is input from the operation receiving unit 110, for example.

The projector side control unit 180 is a computer such as a central processing unit (CPU) or the like. The projector side control unit 180 may be configured to include one or a plurality of processing apparatuses. The projector side control unit 180 realizes a first connection unit 181, an inquiry unit 182, a second connection unit 183, and a display control unit 184 by reading and executing the program stored in the projector side storage unit 170.

When the projector 100 and the first electronic apparatus 200 are not at a connection establishment state in which a communication connection between the projector 100 and the first electronic apparatus 200 is established, the first connection unit 181 controls a communication connection with the first electronic apparatus 200 or the second electronic apparatus 300. For example, when receiving a valid password from the first electronic apparatus 200 via the projector side communication unit 160 in a state in which the connection is not established, the first connection unit 181 establishes a communication connection with the first electronic apparatus 200. The connection establishment state is an example of a first state.

In the connection establishment state, when receiving a searching request from the second electronic apparatus 300 via the projector side communication unit 160, the inquiry unit 182 inquires of the first electronic apparatus 200 for a communication connection with the second electronic apparatus 300. The searching request is a request for searching for a candidate to be communicatively connected with a transmission source of the searching request. The searching request is an example of a request for communication.

The second connection unit 183 receives a response to the inquiry from the inquiry unit 182, from the first electronic apparatus 200 in the connection establishment state.

When the response to the inquiry indicates permission for a communication connection with the second electronic apparatus 300, the second connection unit 183 establishes the communication connection with the second electronic apparatus 300.

For example, when the response to the inquiry indicates the permission, the second connection unit 183 establishes a communication connection with the second electronic apparatus 300 according to a reception of a subsequent connection request from the second electronic apparatus 300.

In other words, when the response to the inquiry indicates permission, the second connection unit 183 establishes a communication connection with the second electronic apparatus 300 according to a reception of a subsequent connection request from the second electronic apparatus 300, without receiving a valid password from the second electronic apparatus 300.

When the response to the inquiry indicates permission, the second connection unit 183 may establish a communication connection with the second electronic apparatus 300 regardless of a connection request from the second electronic apparatus 300.

Here, the connection request is a request for a communication connection with a transmission source of the connection request.

The display control unit 184 controls the projection unit 140 by using the image processing unit 120, the light valve driving unit 130, and the light source driving unit 150. For example, the display control unit 184 causes the projection unit 140 to execute an operation of projecting an image according to image information received by the projector side communication unit 160 from at least one of the first electronic apparatus 200 and the second electronic apparatus 300 onto the projection surface 500.

### A3: Configuration Example of First Electronic Apparatus 200

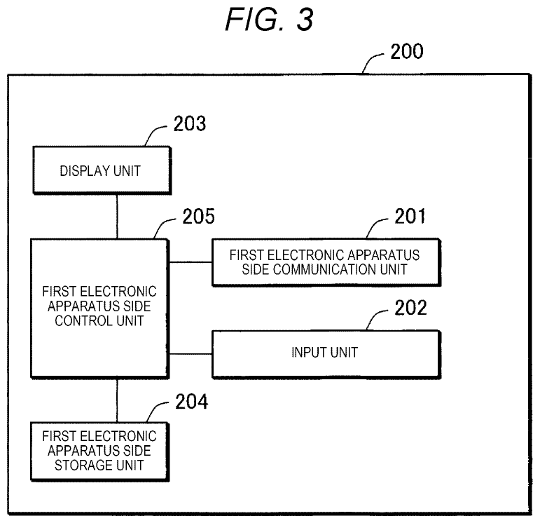

FIG. 3 is a diagram illustrating an example of the first electronic apparatus 200. The first electronic apparatus 200 includes a first electronic apparatus side communication unit 201, an input unit 202, a display unit 203, a first electronic apparatus side storage unit 204, and a first electronic apparatus side control unit 205.

The first electronic apparatus side communication unit 201 wirelessly communicates with the projector 100. The input unit 202 is, for example, a keyboard or a touch panel, and receives various inputs from the teacher. The display unit 203 displays various information. The first electronic apparatus side storage unit 204 is a recording medium configured to be read by a computer. The first electronic apparatus side storage unit 204 stores a program which defines an operation of the first electronic apparatus 200 and various information. The first electronic apparatus side control unit 205 is a computer such as a CPU or the like. The first electronic apparatus side control unit 205 may be configured to include one or a plurality of processing apparatuses. The first electronic apparatus side control unit 205 controls the first electronic apparatus 200 by reading and executing the program stored in the first electronic apparatus side storage unit 204.

### A4: Description of Operation of Display System 1

Hereinafter, an example in which the first electronic apparatus 200 used by the teacher is communicatively connected to the projector 100 by using a valid password, and then the second electronic apparatus 300 used by the student is communicatively connected to the projector 100 will be described.

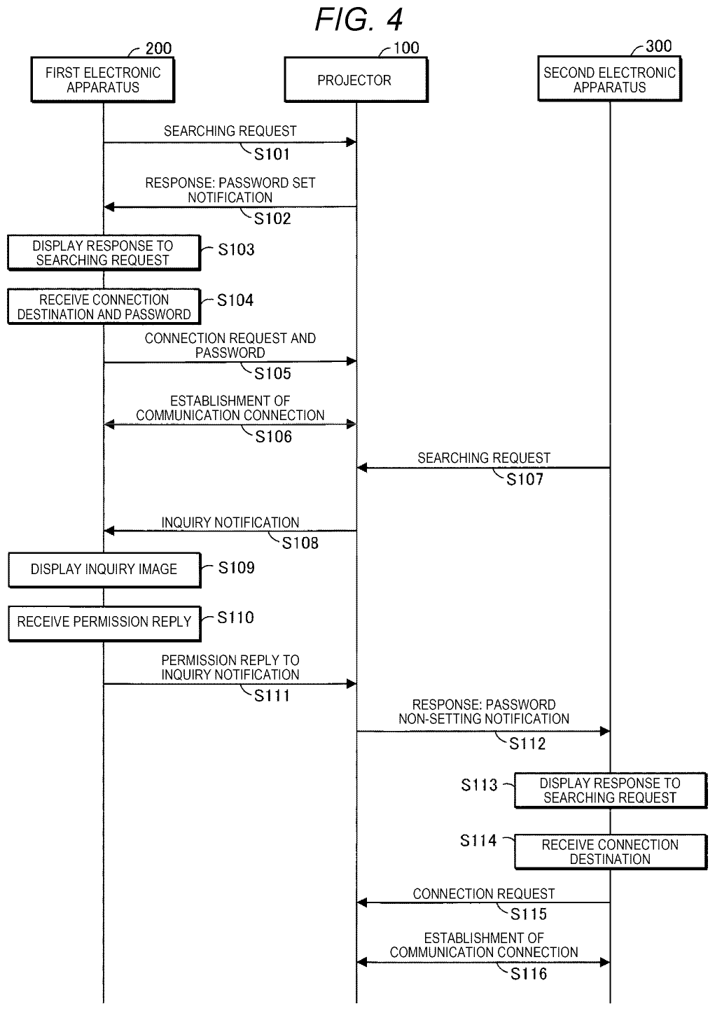

FIG. 4 is a sequence diagram for explaining an operation when a response from the first electronic apparatus 200 to an inquiry from the inquiry unit 182 indicates permission of a communication connection with the second electronic apparatus 300, in other words, a sequence diagram for explaining a control method of the display system 1.

In step S101, the first electronic apparatus side control unit 205 of the first electronic apparatus 200 transmits a searching request from the first electronic apparatus side communication unit 201 according to an input operation by the teacher to the input unit 202.

When receiving the searching request in which the first electronic apparatus 200 is set as a transmission source, in step S102, the first connection unit 181 of the projector 100 transmits a password set notification indicating that a password is set, to the first electronic apparatus 200 as a response to the searching request. Here, the password setting means that it is necessary to input a valid password for a communication connection with the projector 100.

When receiving a response to the searching request from the projector 100, in step S103, the first electronic apparatus side control unit 205 of the first electronic apparatus 200 displays the response to the searching request, that is, the password set notification in this case, on the display unit 203. For example, in step S103, the display unit 203 displays the projector 100 as an apparatus configured to be communicably connected to the first electronic apparatus 200, and displays that a password is set to the projector 100.

When connecting the first electronic apparatus 200 to the projector 100, the teacher operates the input unit 202 to select the projector 100 as a communication connection destination of the first electronic apparatus 200 and to input a password.

When the input unit 202 receives the selection of the projector 100 and the password from the teacher in step S104, in step S105, the first electronic apparatus side control unit 205 transmits a connection request for requesting a connection with the projector 100 and the password to the projector 100.

When receiving the connection request and the password from the first electronic apparatus 200, the first connection unit 181 of the projector 100 determines whether or not the password received from the first electronic apparatus 200 is a valid password stored in the projector side storage unit 170. When the password received from the first electronic apparatus 200 is the valid password, the first connection unit 181 successfully authenticates the first electronic apparatus 200.

When the password received from the first electronic apparatus 200 is different from the valid password, the first connection unit 181 fails in the authentication of the first electronic apparatus 200, does not establish a communication connection with the first electronic apparatus 200, and transmits an authentication failure notification indicating authentication failure to the first electronic apparatus 200.

When the first connection unit 181 succeeds in the authentication of the first electronic apparatus 200, in step S106, the first connection unit 181 establishes a communication connection between the projector 100 and the first electronic apparatus 200 by transmitting a connection permission notification for permitting a connection to the projector 100, to the first electronic apparatus 200.

Next, in step S107, the second electronic apparatus 300 transmits a searching request according to an operation by the student.

When receiving the searching request in which the second electronic apparatus 300 is set as a transmission source in the connection establishment state, in step S108, the inquiry unit 182 of the projector 100 transmits an inquiry notification for inquiring whether or not a communication connection with the second electronic apparatus 300 is permitted, to the first electronic apparatus 200.

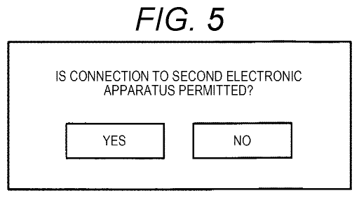

When receiving the inquiry notification, in step S109, the first electronic apparatus side control unit 205 of the first electronic apparatus 200 displays an inquiry image for inquiring whether or not the communication connection with the second electronic apparatus 300 is permitted, on the display unit 203. For example, the image illustrated in FIG. 5 is used as the inquiry image. The inquiry image is not limited to the image illustrated in FIG. 5, and can be appropriately changed. Here, as another point of view for the display of the inquiry image, the inquiry unit 182 causes the first electronic apparatus 200 to display the inquiry notification by transmitting the inquiry notification to the first electronic apparatus 200.

Returning to FIG. 4, for example, when a communication connection between the second electronic apparatus 300 and the projector 100 is permitted so as to project an image based on image information output by the second electronic apparatus 300 used by the student onto the projector 100, the teacher operates the input unit 202 to input a permission reply of indicating permission of the communication connection with the second electronic apparatus 300.

When the input unit 202 receives the permission reply in step S110, the first electronic apparatus side control unit 205 transmits a permission reply to the projector 100 as a response to the inquiry in step S111.

When receiving the permission reply, the second connection unit 183 of the projector 100 releases the password setting for the second electronic apparatus 300 and transmits a password non-setting notification indicating that a password is not set, to the second electronic apparatus 300 as a response to the searching request in step S112. In addition, the permission reply may include a release instruction for releasing a password setting. In this case, the second connection unit 183 releases the password setting according to the release instruction.

When receiving the password non-setting notification from the projector 100, the second electronic apparatus 300 displays the projector 100 as an apparatus configured to be communicably connected to the second electronic apparatus 300 in step S113. In step S113, the second electronic apparatus 300 may also display that a password is not set to the projector 100.

When connecting the second electronic apparatus 300 to the projector 100, the student operates the second electronic apparatus 300 to select the projector 100 as a communication connection destination of the second electronic apparatus 300. At this time, the student does not need to input a valid password.

When receiving the selection of the projector 100 from the student in step S114, in step S115, the second electronic apparatus 300 transmits a connection request for requesting a connection with the projector 100 to the projector 100.

When receiving the connection request from the second electronic apparatus 300, in step S116, the second connection unit 183 of the projector 100 establishes a communication connection between the projector 100 and the second electronic apparatus 300 by transmitting a connection permission notification for permitting a connection to the projector 100, to the second electronic apparatus 300.

For this reason, since the student can connect the second electronic apparatus 300 to the projector 100 without inputting a valid password to the second electronic apparatus 300, it is possible to reduce inconvenience that the student inputs the password.

A response from the first electronic apparatus 200 which is communicatively connected by using a valid password can be regarded as reliable information. Since the communication connection with the second electronic apparatus 300 is established based on the reliable information, it is possible to suppress a decrease in a level of security related to the communication connection with the projector 100.

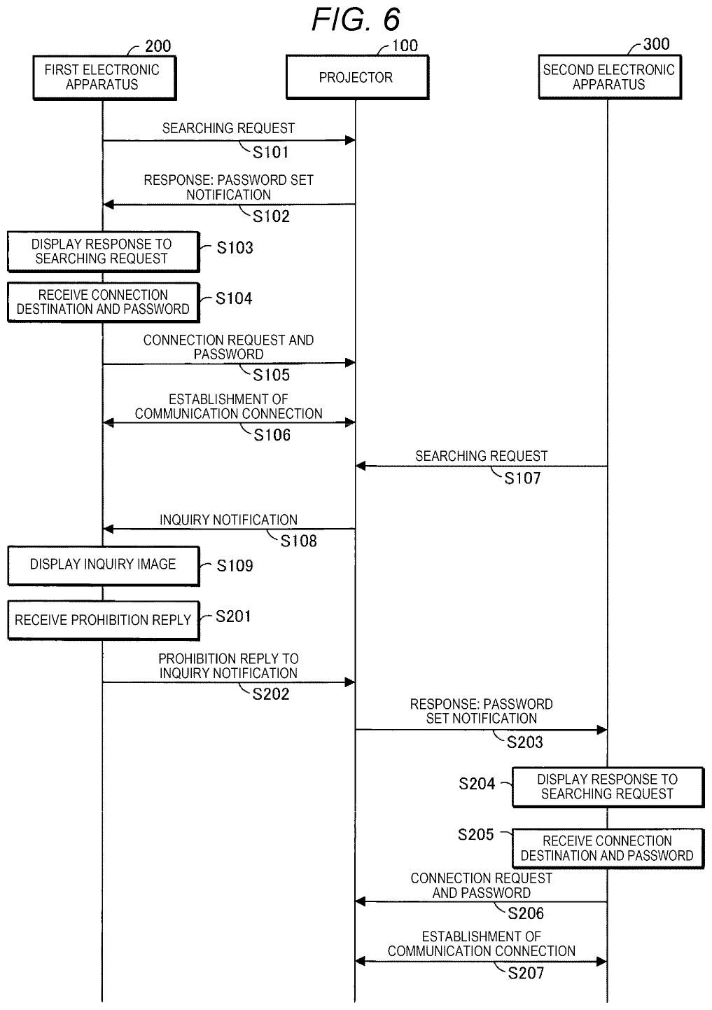

FIG. 6 is a sequence diagram for explaining an operation when a response from the first electronic apparatus 200 to an inquiry from the inquiry unit 182 indicates prohibition of a communication connection with the second electronic apparatus 300. In the process illustrated in FIG. 6, the same processes as those illustrated in FIG. 4 are denoted by the same reference numerals. Hereinafter, among the processes illustrated in FIG. 6, the processes different from the process illustrated in FIG. 4 will be mainly described.

When the second electronic apparatus 300 indicated in an inquiry image in step S109 is not an electronic apparatus recognized by the teacher, the teacher operates the input unit 202 to input a prohibition reply indicating that a communication connection with the second electronic apparatus 300 described in the inquiry image is prohibited.

When receiving the prohibition reply in step S201, the first electronic apparatus side control unit 205 of the first electronic apparatus 200 transmits a prohibition reply to the projector 100 as a response to the inquiry in step S202.

When receiving the prohibition reply, the second connection unit 183 of the projector 100 performs a password setting and in step S203, the second connection unit 183 transmits a password set notification to the second electronic apparatus 300 as a response to the searching request. When the password is already set at a time of receiving the prohibition reply, the second connection unit 183 maintains the password setting. Here, the prohibition reply from the first electronic apparatus 200 may include a release setting for setting a password. In this case, the second connection unit 183 executes the password setting according to the setting instruction.

When receiving a response to the searching request from the projector 100, in step S204, the second electronic apparatus 300 displays the response to the searching request, that is, the password set notification in this case. This display is, for example, the same as the display in step S103.

In a state in which the teacher prohibits a communication connection of the second electronic apparatus 300, for example, in a state in which the teacher mistakenly prohibits the communication connection, when connecting the second electronic apparatus 300 with the projector 100, the student operates the second electronic apparatus 300 to select the projector 100 as a communication connection destination of the second electronic apparatus 300 and to input a password.

When receiving the selection of the projector 100 and the password from the student in step S205, in step S206, the second electronic apparatus 300 transmits a connection request for requesting a connection with the projector 100 and the password to the projector 100.

When receiving the connection request and the password from the second electronic apparatus 300, the second connection unit 183 of the projector 100 determines whether or not the password received from the second electronic apparatus 300 is a valid password. When the password received from the second electronic apparatus 300 is the valid password, the second connection unit 183 successfully authenticates the second electronic apparatus 300.

When the second connection unit 183 succeeds in the authentication of the second electronic apparatus 300, in step S207, the second connection unit 183 establishes a communication connection between the projector 100 and the second electronic apparatus 300 by transmitting a connection permission notification for permitting a connection to the projector 100, to the second electronic apparatus 300.

In this manner, when the second connection unit 183 receives a valid password from the second electronic apparatus 300 even when a response to an inquiry from the first electronic apparatus 200 is a prohibition reply, the second connection unit 183 establishes a communication connection with the second electronic apparatus 300.

For this reason, even when the teacher mistakenly inputs the prohibition reply, the student can communicatively connect the second electronic apparatus 300 to the projector 100 without inputting the valid password to the second electronic apparatus 300.

When a password received from the second electronic apparatus 300 is different from the valid password in a state in which a response to an inquiry from the first electronic apparatus 200 is a prohibition reply, the second connection unit 183 does not establish a communication connection with the second electronic apparatus 300.

### A5: Description of Operation of Projector 100

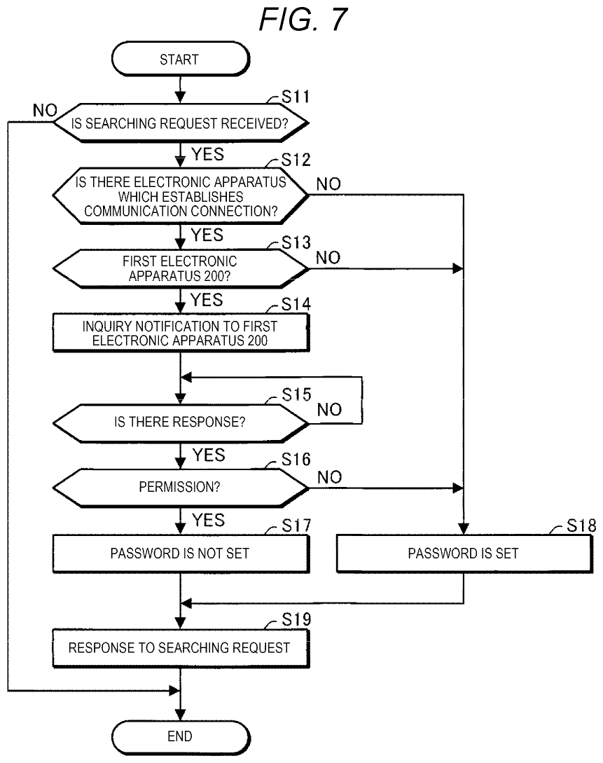

FIG. 7 is a flowchart for explaining in detail an operation since a searching request is received until a response to the searching request is transmitted, among operations of the projector 100.

When receiving a searching request in step S11, in step S12, the first connection unit 181 determines whether or not there is an electronic apparatus which establishes a communication connection with the projector 100.

When there is no electronic apparatus which establishes a communication connection in step S12, the first connection unit 181 performs a password setting in step S18. When a password is already set, the first connection unit 181 maintains the password setting in step S18. Next, the first connection unit 181 transmits a response to the searching request, to a transmission source of the searching request in step S19. In step S19, when a password is set, a password set notification is used for a response to the searching request.

When there is an electronic apparatus which establishes a communication connection in step S12, in step S13, the first connection unit 181 determines whether or not the electronic apparatus establishes the communication connection with the first electronic apparatus 200. When the electronic apparatus does not establish the communication connection with the first electronic apparatus 200 in step S13, step S18 is executed.

When the electronic apparatus establishes the communication connection with the first electronic apparatus 200 in step S13, in step S14, the inquiry unit 182 transmits an inquiry notification to the first electronic apparatus 200.

Next, when receiving a response to the inquiry notification in step S15, the second connection unit 183 determines whether or not the response to the inquiry notification is a permission reply in step S16.

When the response to the inquiry notification is a permission reply in step S16, in step S17, the second connection unit 183 releases a password setting and is at a state in which a password is not set. When a password is already not set, the second connection unit 183 maintains the password non-setting state in step S17.

Next, the second connection unit 183 transmits a response to the searching request, to a transmission source of the searching request in step S19. In step S19, when a password is not set, a password non-setting notification is used for a response to the searching request.

If the response to the inquiry notification is a prohibition reply in step S16, step S18 is executed.

In this manner, when the first electronic apparatus 200 used by the teacher who is a highly reliable user authenticated by a valid password is set as a transmission destination of an inquiry notification, it is possible to increase reliability of a response to the inquiry notification. Since the communication connection with the second electronic apparatus 300 can be controlled based on the highly reliable response, it is possible to suppress a decrease in a level of security related to the communication connection with the projector 100. The first electronic apparatus 200 used by the teacher may be set in advance as a transmission destination of an inquiry notification in a state in which there is another first electronic apparatus 200 authenticated by a valid password in addition to the first electronic apparatus 200 used by the teacher, and the other first electronic apparatus 200 authenticated by the valid password may be used.

### A6: Description of Operation of First Electronic Apparatus 200

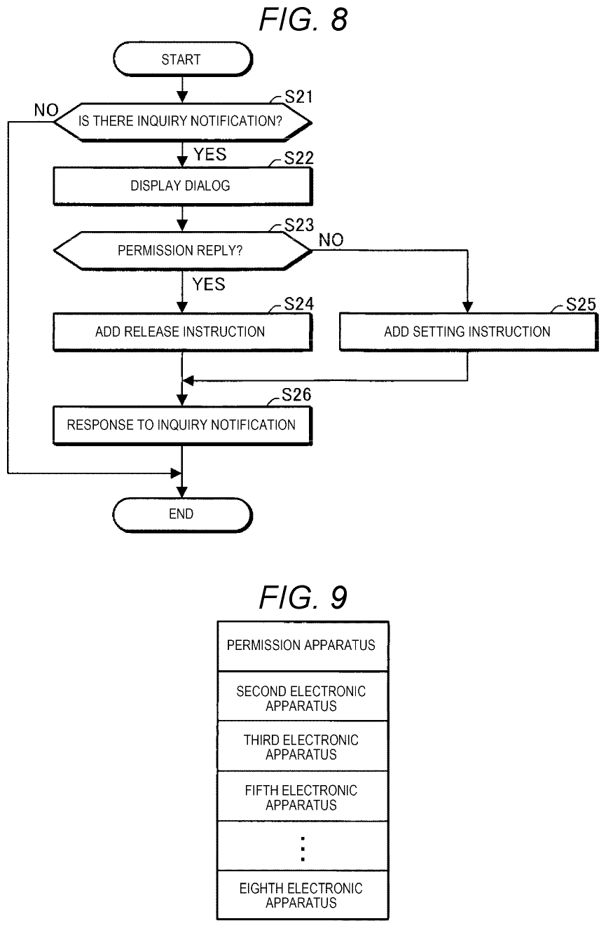

FIG. 8 is a flowchart for explaining in detail an operation since an inquiry notification is received until a response to the inquiry notification is transmitted, among operations of the first electronic apparatus 200. In the operation illustrated in FIG. 8, a permission reply includes a release instruction, and a prohibition reply includes a setting instruction.

When receiving an inquiry notification in step S21, the first electronic apparatus side control unit 205 causes the display unit 203 to display a dialog according to the inquiry notification in step S22. An example of the dialog display includes the display illustrated in FIG. 5 described above. According to the dialog display, the teacher uses the input unit 202 so as to input either a permission reply or a prohibition reply as a reply to the inquiry notification.

Next, when the permission reply is input in step S23, the first electronic apparatus side control unit 205 adds a release instruction to the permission reply in step S24. Meanwhile, when the prohibition reply is input in step S23, the first electronic apparatus side control unit 205 adds a setting instruction to the prohibition reply in step S25.

When step S24 is completed, in step S26, the first electronic apparatus side control unit 205 transmits the permission reply to which the release instruction is added, to the projector 100 as a response to the inquiry notification.

Meanwhile, when step S25 is completed, in step S26, the first electronic apparatus side control unit 205 transmits the prohibition reply to which the setting instruction is added, to the projector 100 as a response to the inquiry notification.

In this manner, when the release instruction is added to the permission reply, the projector 100 may release a password setting according to the release instruction, and it is possible to simply determinate whether or not it is necessary to release the password setting. In addition, when the setting instruction is added to the prohibition reply, the projector 100 may execute a password setting according to the setting instruction, and it is possible to simply determinate whether or not it is necessary to execute the password setting.

### B: Modification Example

In the first embodiment, for example, a configuration to be described below may be adopted.

### B1: Modification Example 1

In the first embodiment, the first electronic apparatus 200 may hold permission apparatus information indicating a permitted apparatus for which a communication connection with the projector 100 is permitted, in the first electronic apparatus side storage unit 204. The first electronic apparatus side storage unit 204 is an example of a storage unit. FIG. 9 is a diagram illustrating an example of permission apparatus information. The permission apparatus information is not limited to information illustrated in FIG. 9, and can be appropriately changed.

In this case, when the second electronic apparatus 300 is indicated in the permission apparatus information at a time of receiving an inquiry notification, the first electronic apparatus side control unit 205 transmits a permission reply as a response to the inquiry notification. Meanwhile, when the second electronic apparatus 300 is not indicated in the permission apparatus information at the time of receiving the inquiry notification, the first electronic apparatus side control unit 205 transmits a prohibition reply as a response to the inquiry notification.

According to Modification Example 1, since the response to the inquiry notification can be automatically transmitted, it is possible to reduce a burden on a user of the first electronic apparatus 200 who replies to the inquiry.

### B2: Modification Example 2

In the first embodiment, the projector 100 may hold permission apparatus information. In addition, when there are a plurality of first electronic apparatuses 200, the projector 100 may hold permission apparatus information for each of the first electronic apparatuses 200. In this case, the projector 100 may generate a response to an inquiry notification by using permission apparatus information corresponding to the first electronic apparatus 200 establishing a communication connection.

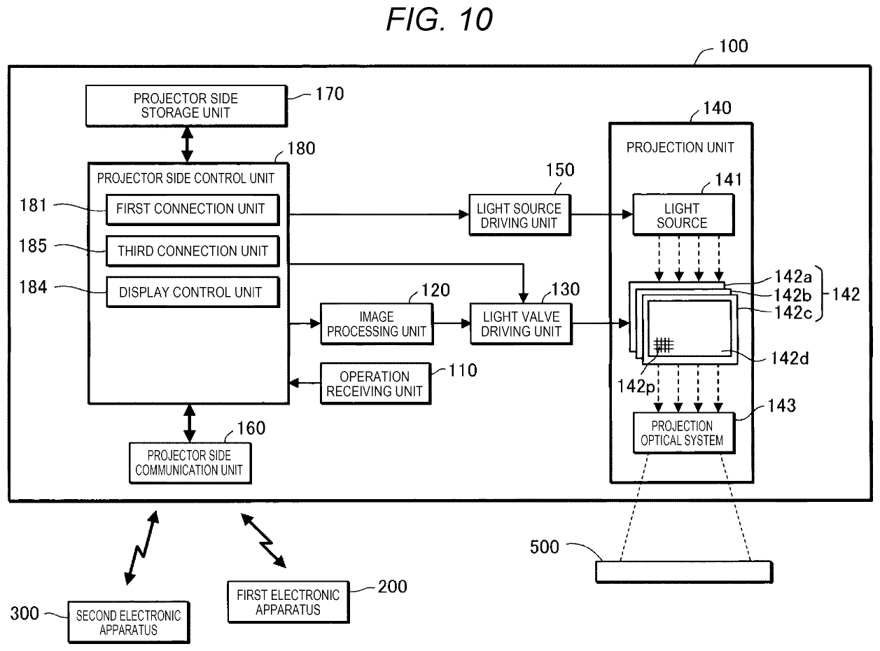

FIG. 10 is a diagram illustrating an example of the projector 100 according to Modification Example 2. In FIG. 10, the same configuration as the configuration illustrated in FIG. 2 is denoted by the same reference numerals. Hereinafter, in the projector 100 illustrated in FIG. 10, the configuration different from the configuration illustrated in FIG. 2 will be mainly described.

The projector 100 illustrated in FIG. 10 is different from the projector 100 illustrated in FIG. 2 in that the projector 100 illustrated in FIG. 10 includes a third connection unit 185 without the inquiry unit 182 and the second connection unit 183, and the projector side storage unit 170 holds permission apparatus information corresponding to the first electronic apparatus 200 for each of the first electronic apparatuses 200. Permitted apparatuses indicated in the respective pieces of permission apparatus information may be different from one another or the same.

The projector side control unit 180 realizes the third connection unit 185 by reading and executing the program stored in the projector side storage unit 170.

When receiving a searching request from the second electronic apparatus 300 in a state in which a communication connection with one first electronic apparatus 200 is established, first, the third connection unit 185 determines permission apparatus information corresponding to the first electronic apparatus 200 establishing the communication connection as specific permission apparatus information.

Next, when the second electronic apparatus 300 which is a transmission source of the searching request is indicated in the specific permission apparatus information, the third connection unit 185 establishes a communication connection with the second electronic apparatus 300.

For example, when the second electronic apparatus 300 is indicated in the specific permission apparatus information, the third connection unit 185 establishes a communication connection with the second electronic apparatus 300 according to a reception of a subsequent connection request from the second electronic apparatus 300.

In other words, when the second electronic apparatus 300 is indicated in the specific permission apparatus information, the third connection unit 185 establishes a communication connection with the second electronic apparatus 300 according to a reception of a subsequent connection request from the second electronic apparatus 300, without receiving a valid password from the second electronic apparatus 300.

When the second electronic apparatus 300 is indicated in the specific permission apparatus information, the third connection unit 185 may establish a communication connection with the second electronic apparatus 300 regardless of a connection request from the second electronic apparatus 300.

According to Modification Example 2, it is possible to determine whether or not a valid password is necessary for a communication connection with the second electronic apparatus 300 without performing an inquiry to the first electronic apparatus 200. As compared with the first embodiment and Modification Example 1, it is possible to reduce communication processes related to an inquiry between the projector 100 and the first electronic apparatus 200.

### B3: Modification Example 3

In the first embodiment, Modification Example 1, and Modification Example 2, a user of the first electronic apparatus 200 may be not a teacher but, for example, a chairperson of a conference. In this case, it is desirable that a user of the second electronic apparatus 300 is not a student but a participant in the conference.

### B4: Modification Example 4

In the first embodiment and Modification Example 1 to Modification Example 3, a connection request for requesting a communication connection with the second electronic apparatus 300 may be used as a request related to communication, instead of a searching request.

In this case, for example, in the first embodiment, steps S203 to S206 are performed following step S107 illustrated in FIG. 6, and steps S108 and S109 are performed following step S206.

After then, one of steps S109 and S110 illustrated in FIG. 4 and steps S201 and S202 illustrated in FIG. 6 is performed.

When step S111 is performed, step S116 is subsequently performed.

Meanwhile, if step S202 is executed, when a password transmitted in step S206 is a valid password, step S207 is executed. When the password is not a valid password, a communication connection is not established.

### B5: Modification Example 5

In the first embodiment and Modification Example 1 to Modification Example 4, the display apparatus is not limited to the projector 100 and can be appropriately changed. For example, a liquid crystal display apparatus or an EL display apparatus may be used as a display apparatus.

### B6: Modification Example 6

In the first embodiment and Modification Example 1 to Modification Example 5, all or a part of the function realized by the projector side control unit 180 executing a program may be realized by hardware, for example, by an electronic circuit such as a field programmable gate array (FPGA), an application specific IC (ASIC), or the like.

### B7: Modification Example 7

In the first embodiment and Modification Example 1 to Modification Example 6, the liquid crystal light valve 142 is used as an example of a light modulation device, but the light modulation device is not limited to the liquid crystal light valve and can be appropriately changed. For example, the light modulation device may be configured to use three reflective liquid crystal panels. In addition, the light modulation device may be configured as a method using one liquid crystal panel, a method using three digital mirror devices (DMDs), a method using one digital mirror device, or the like. When only one liquid crystal panel or DMD is used as a light modulation device, members corresponding to a color separation optical system and a color synthesis optical system are unnecessary. In addition to the liquid crystal panel and the DMD, a configuration of modulating light emitted from the light source 141 can be adopted as a light modulation device.

What is claimed is:

1. A display apparatus comprising:
a first connection unit that establishes a communication connection with a first electronic apparatus when receiving valid authentication information from the first electronic apparatus;
an inquiry unit that executes an inquiry for a communication connection with a second electronic apparatus to the first electronic apparatus when receiving a request related to communication from the second electronic apparatus in a state in which the communication connection with the first electronic apparatus is established; and
a second connection unit that establishes the communication connection with the second electronic apparatus when a response to the inquiry indicates permission for the communication connection with the second electronic apparatus.

2. The display apparatus according to claim 1, wherein
the request related to the communication is a searching request for searching for a candidate to be communicatively connected with the second electronic apparatus.

3. The display apparatus according to claim 1, wherein
the request related to the communication is a connection request for requesting the communication connection with the second electronic apparatus.

4. The display apparatus according to claim 1, wherein
when the response indicates prohibition for the communication connection with the second electronic apparatus, the second connection unit establishes the communication connection with the second electronic apparatus when receiving the valid authentication information from the second electronic apparatus.

5. The display apparatus according to claim 1, wherein
the inquiry unit causes the first electronic apparatus to display the inquiry and
after the first electronic apparatus receives an input of a reply to the inquiry from a user, the second connection unit receives the reply as the response from the first electronic apparatus.

6. A display apparatus comprising:
a first connection unit that establishes a communication connection with a first electronic apparatus when receiving valid authentication information from the first electronic apparatus; and
a third connection unit that establishes a communication connection with a second electronic apparatus when receiving a request related to communication from the second electronic apparatus in a first state in which the communication connection with the first electronic apparatus is established and when the second electronic apparatus is indicated in permission apparatus information indicating an electronic apparatus for which a communication connection with the display apparatus is permitted in the first state.

7. A display system comprising:
a display apparatus;
a first electronic apparatus; and
a second electronic apparatus, wherein
the first electronic apparatus transmits valid authentication information and transmits a response to an inquiry for a communication connection with the second electronic apparatus,
the second electronic apparatus transmits a request related to communication, and
the display apparatus includes
a first connection unit that establishes a communication connection with the first electronic apparatus when receiving the valid authentication information from the first electronic apparatus,
an inquiry unit that executes the inquiry to the first electronic apparatus when receiving a request related to the communication from the second electronic apparatus in a state in which the communication connection with the first electronic apparatus is established, and
a second connection unit that establishes the communication connection with the second electronic apparatus when a response to the inquiry indicates permission for the communication connection with the second electronic apparatus.

8. The display system according to claim 7, wherein
the first electronic apparatus
includes a storage unit which holds permission apparatus information indicating an electronic apparatus for which a communication connection with the display apparatus is permitted and
transmits a permission reply indicating permission for the communication connection with the second electronic apparatus as the response when the second electronic apparatus is indicated in the permission apparatus information at the time of receiving the inquiry.

9. A control method of a display apparatus, the method comprising:
establishing a communication connection with a first electronic apparatus when receiving valid authentication information from the first electronic apparatus;
executing an inquiry for a communication connection with a second electronic apparatus to the first electronic apparatus when receiving a request related to communication from the second electronic apparatus in a state in which the communication connection with the first electronic apparatus is established; and
establishing the communication connection with the second electronic apparatus when a response to the inquiry indicates permission for the communication connection with the second electronic apparatus.
